(19) United States
(12) Patent Application Publication
(10) Pub. No.: US 2004/0122144 A1
(43) Pub. Date: Jun. 24, 2004

(54) Method for enhancing flexural bond strength mortar

(75) Inventors: Milind V. Karkare, Decatur, GA (US); Chia-Chih Ou, Lexington, MA (US); Craig T. Walloch, Arlington, MA (US); Ara A. Jeknavorian, Chelmsford, MA (US)

Correspondence Address: Craig K. Leon, Esq., W. R. Grace & Co.-Conn., Patent Department, 62 Whittemore Avenue, Cambridge, MA, 02140, US

(73) Assignee: W.R. GRACE & CO.-CONN.

(21) Appl. No.: 10/683,366

(22) Filed: Oct. 10, 2003

Related U.S. Application Data
(62) Division of application No. 09/230,534, filed on May 25, 1999, now abandoned.
Application No. 09/230,534 is a 371 of international application No. PCT/US97/13750, filed on Aug. 5, 1997.

(51) Int. Cl. C08K 5/09

(52) U.S. Cl. 524/284; 524/318; 524/558

(57) ABSTRACT

Admixture or additive which provides water-repellency and flexural bond strength improvement in mortar, concrete, or cement, and particularly in masonry mortars. An exemplary admixture composition includes: (a) at least one C₈-C₃₀ fatty acid or a derivative thereof, such as a salt, ester, or triglyceride; and (b) a flexural bond strength enhancing material comprising a polymer having a backbone to which are attached carboxyl cement anchoring groups and oxyalkylene groups attached by linkages selected from the group consisting of an amide, an imide, and an ester. A preferred additive optionally includes an air entraining admixture for improving workability of a masonry mortar into which the fatty acid or derivative and the flexural bond strength enhancing material are added. A cementitious composition and method for enhancing water-repellency and flexural bond strength in a masonry mortar are also disclosed.

### FIELD OF THE INVENTION

The present invention relates to a hydraulic cement admixture, and more particularly to an admixture for improving flexural bond strength and water repellency in masonry mortar, comprising (a) a C₈-C₃₀ fatty acid or derivative thereof (such as a salt, ester, or triglyceride); (b) a flexural bond strength enhancing material comprising a polymer having a backbone to which are attached carboxyl cement anchoring groups and oxyalkylene groups; and, optionally, (c) an air entraining adminxture for improving workability of a mortar into which the admixture is introduced. The invention also relates to a cement composition containing the admixture components, and a method for improving masonry mortar flexural bond strength involving the admixture components.

### BACKGROUND OF THE INVENTION

Masonry mortar is the bonding agent used for integrating concrete blocks, clay bricks, concrete masonry units, and other masonry units into building or civil engineering structures. A function of the mortar is to provide a complete, strong, durable bond between the masonry units.

Another function of the mortar is to prevent leakage. Thus, water protection is a major performance consideration in masonry design. For example, a leaky masonry wall can lose durability and aesthetic appearance, such as through freeze-thaw damage, efflorescence, and interior surface damage, due to moisture penetration. To minimize the effect of moisture or water leakage in concrete masonry units, it is known to incorporate into the masonry unit and/or mortar a water-repellent material such as calcium stearate, which is available, for example, from PPG Industries, Pittsburgh, Pa. Other water-repellent materials that can be used in concrete masonry units and mortars include soaps, fatty acids, wax emulsions, and methyl silicones. The addition of water-repellent materials effectively minimizes penetration of water through the individual masonry units and mortar joints.

However, one of the problems seen by the present inventors is that the incorporation of a water-repelling material into the mortar leads to the reduction in the flexural bond strength of the resultant mortar joint when cured. Flexural bond strength is conceptually different than compressive strength. For example, when a downward compressive load, such as the weight of a roof, is exerted upon a wall made of stacked bricks joined by mortar, the stress level placed thereupon is more or less evenly distributed over the mortar joint. However, flexural load is placed upon the a mortar joint, for example, by the force of wind directed against a free-standing brick wall. In this case, the force on a particular mortar joint is not evenly distributed, but is rather akin to pulling one side of adjoining bricks apart in tension while forcing the other sides together in compression.

It is a purpose of the present inventors to discover a novel admixture and metho2d for obtaining water repellency while avoiding a loss of flexural bond strength.

### SUMMARY OF THE INVENTION

In surmounting the disadvantages of prior art, the present invention provides a composition for improving water repellency and flexural bond strength in a masonry mortar, comprising: (a) at least one C₈-C₃₀ fatty acid or derivative thereof, such as a salt, ester, or triglyceride; and (b) at least one flexural bond strength enhancing material comprising a polymer having a carbon-containing backbone to which are attached cement-anchoring members and oxyalkylene groups attached by linkages selected from the group consisting of an amide, an imide, and an ester. Preferred fatty acid salts are calcium stearate and zinc stearate.

In a preferred admixture composition of the invention, an air entraining agent may be further incorporated to increase the workability of a masonry mortar into which the above-described admixture components are introduced. The air entraining agent may be grafted onto the flexural bond strength enhancing polymer backbone or otherwise separately included with the other admixture components, and/or added to the masonry mortar separately.

The term “cement anchoring” is meant to refer to ionic bonds formed between the polymer's carboxylate groups and the calcium cations in the wet cementitious mortar, while non-ionic pendant groups on the polymer backbone are believed to facilitate the dispersion of cement particle within the aqueous mortar mixture. Exemplary comb polymers comprise a backbone formed from ethylenically-unsaturated monomers, and, as nonionic pendant groups on the backbone, ethylene oxide (“EO”) groups, propylene oxide (“PO”) groups, or as combination (generally referred to as “EO/PO”) groups.

The invention also provides a cementitious composition, such as a masonry mortar, comprising a cementitous binder; at least one C₈-C₃₀ fatty acid or derivative thereof (e.g., salt, ester, or triglyceride); at least one flexural bond strength polymer as above described; and, preferably, at least one air entraining admixture (AEA).

An exemplary method of the invention involves providing, in a hydraulic cementitious composition, such as a mortar, at least one C₈-C₃₀ fatty acid or derivative thereof; and at least one flexural bond strength enhancing material as described above. Preferably, a fatty acid salt (such as calcium stearate or zinc stearate) is added in dispersion form, and, more preferably, pre-mixed with the flexural bond strength enhancing material. Another exemplary method further comprises introducing an air entraining admixture, either separately or premixed with the fatty acid and flexural bond strength enhancing components, to improve workability of a masonry mortar or cement into which the components are added.

Further features and advantages of the invention are provided hereinafter.

### DETAILED DESCRIPTION OF EXEMPLARY EMBODIMENTS

The term “cement composition” as may be used herein refers to pastes, mortars, grouts such as oil well cementing grouts, and concrete compositions comprising a hydraulic cement binder. The terms “paste”, “mortar” and “concrete” are terms of art, pastes are mixtures composed of a hydraulic cement binder (usually, but not exclusively, Portland cement, Masonry cement, or Mortar cement and may also include limestone, hydrated lime, fly ash, blast furnace slag, and silica fume or other materials commonly included in such cements) and water; mortars are pastes additionally including fine aggregate, and concretes are mortars additionally including coarse aggregate. The cement compositions of this invention may be formed by mixing required amounts of certain materials, e.g., a hydraulic cement, water, and fine or coarse aggregate, as may be applicable to make the particular cement composition being formed.

Exemplary admixtures of the invention comprise at least one C₈-C₃₀ fatty acid or derivative thereof, such as an ester or salt (e.g., calcium stearate) preferably in an aqueous form (e.g., a dispersion), and at least one flexural bond strength enhancing material.

An exemplary masonry additive composition of the invention comprises a fatty acid or derivative thereof (e.g., salt, ester, triglyceride) in the amount of 5 to 97% and more preferably 30-95% (dry) weight total solids; a flexural bond strength enhancing polymer, as described above and further hereinafter, in the amount of 1 to 95% and more preferably 3-70%, (dry) weight total solids; and, optionally (but preferably) an air entraining agent in the amount of 0.01 to 10.0%, and more preferably 0.3-3.0%, (dry) weight total solids (the percentages based on the total dry weight solids of the masonry additive components when combined together).

The C₈-C₃₀ fatty acid or a derivative thereof can be represented by the formula

R_{FA}COO-A

wherein R_{FA} represents a C₇-C₂₉ (or more preferably a C₉-C₁₉) alkyl(ene) group; and A=H, a C₁-C₁₂ linear or branched alkyl group, an alkali or alkaline earth metal cation, a polyvalent cation, glycerol moiety (e.g., a polyhydroxy alcohol), or a C₁-C₁₂ linear or branched alkyl or alkanol amine. The term “alkyl(ene)” is meant herein to encompass linear or branched alkyl and alkylene groups. Preferred fatty acids and fatty acid derivatives are calcium stearate and palmitate, zinc stearate and palmitate, butyl stearate and palmitate, tall oil which contains oleic and lineoleic acid, sodium tallate, potassium tallate, butyl oleate, or mixtures thereof. Myristates and laurates are also preferred. Particularly preferred is calcium stearate, which is commercially available in dispersion form that may include a mixture of calcium stearate, palmitate and other fatty acids.

Exemplary flexural bond strength enhancing materials of the present invention can comprise a polymer backbone to which are attached carboxyl cement anchoring groups and non-ionic pendant groups as further described hereinafter.

Preferred flexural bond strength enhancing materials comprise imidized acrylic polymers or copolymers thereof, such as those taught in U.S. Pat. No. 5,393,343 assigned to W. R. Grace & Co.-Conn. and incorporated herein by reference. The polymer which is imidized is an “acrylic polymer,” by which term is meant, for example, a homopolymer or copolymer of acrylic acid, methacrylic acid, their alkali metal salts, as well as their C₁-C₃₀ alkyl esters. Additionally, the acrylic polymer reactant and the resultant imidized acrylic polymer may contain units derived from other singly and doubly ethylenically unsaturated monomers, such as styrene, alpha-methystyrene, sulfonated styrene, maleic acid, acrylonitrile, butadiene and the like. Such other ethylenically unsaturated monomer derived units, when present, can be present in the polymer in amount of up to about 20 (preferably, up to about 10) weight percent of the total polymer, provided that the resultant imidized acrylic polymer is water soluble.

The imidized acrylic polymer may be formed such as by reacting an acrylic polymer with ammonia or an alkoxylated amine. The amine reactant useful in forming the desired acrylic polymer can be selected from ammonia or an alkyl-terminated alkoxy amine represented by the formula:

H₂N—(BO)ₙ—R″

in which BO represents a C₂-C₁₀ (preferably a C₂-C₄) oxyalkylene group in which O represents an oxygen atom and B represents a C₂-C₁₀ (preferably a C₂-C₄) alkylene group or mixture; and R″ represents a C₁-C₁₀ (preferably C₁-C₄) alkyl group and n is an integer selected from 1 to 200 and preferably from 1 to 70. The reaction conditions and catalysts are generally known. See e.g., U.S. Pat. No. 5,393,343 at Columns 3-4. (The designation “B” does not represent boron).

An exemplary imidized acrylic polymer that is suitable for use as a flexural bond strength enhancing material in the present invention has the structural formula of

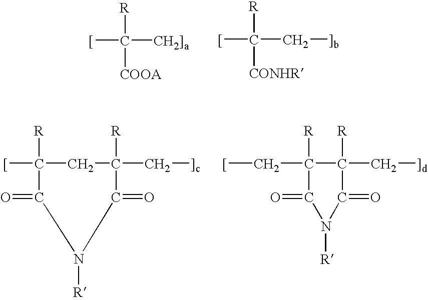

wherein each R independently represents a hydrogen atom or a methyl group (CH₃ group); A represents a hydrogen atom, a C₁-C₁₀ (preferably C₂-C₄) oxyalkylene group (BO) or a plurality (1-200, preferably from 1 to 70) of said groups which is terminated with a C₁-C₁₀ alkyl group (R″) or mixtures thereof; and a, b, c, and d represent molar percentages of the polymer's structure such that a has a value of about 50-70; the sum of c plus d is at least 2 to a value of (100−a) and is preferably from 3 to 10; and b is not more than [100−(a+b+d)].

An exemplary imidized acrylic polymer useful as a flexural bond strength enhancing material herein is represented by the above formula in which A is a hydrogen atom or an alkali metal cation; R′ is at least from 50-90 weight percent of the polymer and comprises polyoxyethylene or polyoxypropylene units or mixtures thereof. Further, a may have a numerical value of from 60-70, and the sum of c and d is a numerical value of at least 3 (preferably at least 5) to the value of (100−a).

Further exemplary flexural bond strength enhancing materials can be obtained by polymerization of ethylenically-unsaturated carboxylic acids to form the backbone, and grafting or otherwise attaching to the backbone a number of other non-ionic pendant groups. The backbone may comprise carboxylic acid grafting sites to which are covalently attached air-detraining functional side chains. The carbon backbone may optionally contain intervening atoms like oxygen (i.e., ether linkage). Suitable grafting sites include free carboxylic acid (or salt thereof) groups. Carbon backbones may be made by polymerization of ethylenically-unsaturated monomers, preferably ethylenically-unsaturated carboxylic acids (e.g., allyl carboxylic acids) such as acrylic, methacrylic, maleic, fumaric, citraconic, itaconic, (meth)allylsulfonic, vinyl sulfonic, sulfoethyl(meth)acrylic, 2-(meth)acrylamido 2-methylpropane sulfonic, mesaconic, or dicarboxylic acid half-esters. Preferred polycarboxylic acid carbon backbones are, e.g., polyacrylic or polymethacrylic acid. 5- to 200-mers are preferred, more preferably 5- to 150-mers, and 5- to 100-mers particularly preferred. Preferably about 5% or more of the carboxylic acid groups on the polycarboxylic acid backbone remain unesterified, more preferably about 10% or more.

Exemplary non-ionic pendant groups may comprise air detraining functional side chains which function chemically to stabilize entrained air quality and level in the cement or mortar, and are covalently attached to the grafting sites of the carbon backbone. The side chains may therefore comprise polyoxyalkylene groups of the general formula:

R⁴—(OA²)ₓ—Q—

wherein Q=O or NH;

A²=C₁-C₁₀ alkylene;

x=1 to 200; and

R₄=C₁-C₁₀ alkyl.

The term alkyl(ene) is meant herein to encompass linear or branched alkyl(ene) groups, and also include (where structurally possible) aryl(ene) and arylalkyl(ene) groups. In preferred air detraining functional side chains, A²=C₂-C₅ alkylene; more preferably, the OA² groups are a mixture of ethylene oxide (“EO”) and propylene oxide (“PO”). Air detraining performance appears to be particularly good when the weight ratio of EO/PO in the air detraining functional side chain is from about 3:1 to 0.3:1, more preferably from about 1.5:1 to 0.6:1. Q is preferably O, and x is preferably 1 to 100. R⁴ is advantageously butyl, preferably a n-butyl group. It is believed that a range of polyoxyalkylene alcohols available from Huntsman Chemical Corporation (Houston, Tex.) under the tradename JEFFOX will function suitable when incorporated as air detraining functional side chains in the flexural bond strength enhancing materials of the invention, e.g., JEFFOX WL5000 and WL660. These polyoxyalkylene alcohols have number average molecular weights of about 3500 and 1850, respectively, and have the formula (C₄H₉)(OA²)ₓOH, where OA² is a mixture of EO and PO, and the EO/PO weight ratio is ≈1:1.

Other exemplary polyoxyalkylene amines which can be grafted onto/attached to the carbon backbone of the bond strength enhancing materials herein may have the general formula:

R⁵—O—(A³O)_{y}—(A³)ₚ—NH₂

wherein A³=C₁-C₁₀ alkylene;

y=1 to 200;

p=1 to 50; and

R⁵=C₁-C₁₀ alkyl.

Such polyoxyalkylene amines may be grafted or attached to the carbon backbone by an amide and/or imide linkage, in which case the attached group would have the formula R⁵—O—(A³O)_{y}—(A³)ₚ—N═ (note that the “═” sign is meant to signify two covalent bonds to other atoms, for example, to two carbonyl carbons on the backbone, i.e., imide linkage, or to a hydrogen atom and a carbonyl carbon on the backbone.) In preferred polyoxyalkylene amines, A³=C₂-C₅ alkylene; more preferably, the A³O groups are a mixture of EO and PO. An EO/PO weight ratio of about 7:1 to 0.5:1 has been found suitable. y is preferably in the range of 1 to 100. p is preferably in the range of 1 to 5, more preferably 1 to 2. R⁵ is preferably methyl (CH₃—). For example, polyoxyalkylene amines available from Huntsman Chemical Corporation (Houston, Tex.) under the tradename JEFFAMINE have been found suitable in the invention, e.g., JEFFAMINE M1000 and M2070, having number average molecular weights corresponding to their respective product numbers. The JEFFAMINEs have the formula CH₃O(A³O)_{y}CH₂CH(CH₃)NH₂, where A³O is a mixture of EO and PO.

The mole ratio of the acrylic acid monomer in the polyacrylic acid to a) polyoxyalkylene amine and b) polyoxyalkylene alcohol is generally about 2:1 to 9:1, and the weight ratio of a) to b) is generally about 20:1 to 2:1. It can easily be seen that by varying the amount of the polyoxyalkylene alcohol side chains grafted onto the backbone, flexural bond strength enhancing polymers can be made in accordance with the invention which will produce corresponding variance in entrained air in the cementitious mix. One preferred flexural bond strength enhancing material comprises polyacrylic acid (“PAA”) to which has been grafted a) polyoxyalkylene amines of the formula CH₃O(A³O)_{y}CH₂CH(CH₃)NH₂, where A³O is a mixture of EO and PO and the EO/PO weight ratio is from about 5:1 to 0.5:1 and b) polyoxyalkylene alcohols of the formula (C₄H₉)(OA²)ₓOH, where OA² is a mixture of EO and PO and the EO/PO weight ratio is ≈1:1.

Further exemplary flexural bond strength enhancing materials of the invention may include polymers having the formula

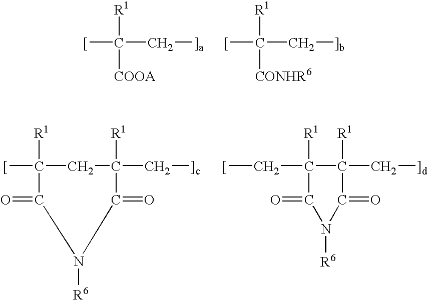

wherein each R¹ independently represents a hydrogen atom or a C₁-C₅ alkyl group; A represents a mixture of Z and R²; Z represents hydrogen atom, monovalent or divalent metal cation, ammonium group or organic amine group; R² represents an air detraining polyoxyalkylene group represented by (BO)ₙ R³ in which O represents an oxygen atom, B represents a C₁-C₁₀ alkylene group, R³ represents a C₁-C₁₀ alkyl group and n represents an integer of from 1-200, or mixtures thereof; R⁶ represents a polyoxyalkylene group represented by (BO)ₙ R³; and a, b, c and d are numerical values representing molar percentage of the polymer's structure such that a is a value of about 1 to 99; the sum of c+d is a value of 0 to the numerical value of (100−a); and b is a remainder value of [100−(a+c+d)].

“a” is preferably from about 30 to 99, more preferably from 50 to 99. In the R² group, B preferably represents a C₂-C₅ alkylene group, R³ represents a C₁-C₄ alkyl group, and n represents an integer of from 1-100. More preferably, the BO groups are a mixture of EO and PO. Air detraining performance appears to be particularly good when the weight ratio of EO/PO is from about 3:1 to 0.3:1, more preferably from about 1.5:1 to 0.6:1. R⁴ is advantageously butyl, preferably a n-butyl group.

R⁶ represents a polyoxyalkylene group represented by (BO)ₙ R³, and is advantageously R⁵—O—(A³O)_{y}—(A³)ₚ—, wherein A³=C₁-C₁₀ alkylene; y=1 to 200; p=1 to 50; and R⁵=C₁-C₁₀ alkyl. Preferably, A³=C₂-C₅ alkylene; more preferably, the A³O groups are a mixture of EO and PO. An EO/PO weight ratio of about 7:1 to 0.5:1 has been found suitable. y is preferably in the range of 1 to 100. p is preferably in the range of 1 to 5, more preferably 1 to 2. R⁵ is preferably methyl (CH₃—). In a particularly preferred embodiment, a) R⁶ is of the formula CH₃O(A³O)_{y}CH₂CH(CH₃)—, where A³O is a mixture of EO and PO, and the EO/PO weight ratio is from about 5:1 to 0.5:1, and b) R² is of the (C₄H₉)(OA²)ₓO—, where OA² is a mixture of EO and PO and the EO/PO weight ratio is ≈1:1.

The exemplary flexural bond strength enhancing materials may be made by grafting a polyoxyalkylene amine onto a polycarboxylic acid backbone (amidization/imidization reaction), then grafting onto the polycarboxylic acid backbone an air detraining polyoxyalkylene alcohol (via esterification reaction). It is believed that the alcohol may also be grafted onto the backbone before grafting the amine onto the backbone. The reactions are carried out in an oxygen-free atmosphere, in a reaction vessel having a condenser for facilitating water removal, e.g., a jacketed-coiled condenser fitted with a DEAN-STARK™ trap. (During the course of the reactions, water (a reaction by-product) is removed to drive the reaction to completion.) In the amidization/imidization step, the reactants which are contacted with each other and heated to 100° C. to about 185° C. for about 1 to 8 hours, preferably about 1.5 to 2.5 hours, or until the amidization/imidization is complete. (Again, reference is made to U.S. Pat. No. 5,393,343, the entire disclosure of which is incorporated herein by reference for further details of the reaction.) For the esterification reaction, a catalyst is added to catalyze the esterification of the polyoxyalkylene alcohol to the graft polymer. Any agent which will catalyze ester formation may be used (i.e., dehydrating agents, defined herein as those which facilitate the formation of water in chemical reactions; such as naphthalene sulfonic acid, carbodiimide, or p-toluene sulfonic acid), with p-toluene sulfonic acid preferred. The temperature is maintained at 100° C. to about 185° C. for about 1 to 8 hours, preferably about 1.5 to 2.5 hours, or until the esterification is complete. Water by-product is removed as above. The reaction vessel is cooled, the reaction product is neutralized and the total solids of the mixture are adjusted with solvent if desired or necessary for addition to a cement composition in a desired dosage. Other methods of preparation may be used as long as the resultant polymer has the characteristics described herein. For example, certain polyoxyalkylene bond strength enhancing polymers of the type obtained by polymerization of ethylenically-polymerizable carboxylic acids and ethylenically-polymerizable polyoxyalkylenes, as exemplified by U.S. Pat. Nos. 4,471,100 and 4,946,904, the entire disclosures of which are incorporated herein by reference, comprise a carbon backbone and grafting sites (carboxylic acid groups). It is intended that air detraining functional side chains as described herein may be esterified to the free carboxylic acid groups of these polyoxyalkylene bond strength enhancing polymers to impart the benefits detailed herein. Such resulting air-controlling bond strength enhancing polymers are intended to be within the scope of our invention.

It will be seen that the flexural bond strength enhancing polymer material can be added at any stage of the cement or mortar's formation or use. For example, the polymer, with or without the one C₈-C₃₀ fatty acid or derivative (preferably, calcium stearate), can be mixed at the cement mill with clinker cement raw material during its grinding to form cement powder. The polymer can also be applied to the cement powder during its blending with other dry materials to prepare a specific type of cement, such as blended cement, pozzolanic cement and the like. Alternately, the improved cements of the invention can be formed in situ during the course of preparing a cement composition such as a mortar mix or a concrete. The flexural bond strength enhancing polymer material, preferably in pre-mixed form together with, as an exemplary fatty acid salt (e.g., calcium stearate, preferably in the form of a dispersion (“CSD”)), can be added as an aqueous solution as part of the water of hydration, or can be added separately.

Further exemplary comb polymers useful as a flexural bond strength enhancing material in the present invention comprise a copolymer of a polyoxyalkylene derivative as represented by the following formula (1) and maleic anhydride, a hydrolyzed product of the copolymer, or a salt of the hydrolyzed product;

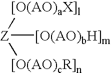

wherein “Z” represents a residue of a compound having from 2 to 8 hydroxy groups; “AO” represents an oxyalkylene group having from 2 to 18 carbon atoms; “X” represents an unsaturated hydrocarbon group having from 2 to 5 carbon atoms; “R” represents a hydrocarbon group having from 1 to 40 carbon atoms; “a” represents 1 to 1,000; “1” represents 1 to 7, “m” represents 0 to 2; and “n” represents 1 to 7; “1”+“m”+“n”=2 to 8, “m”/(“1”+“n”) is less than or equal to ½, and “al”+“bm”+“cn” is equal to or greater than 1. The copolymer shown above is taught in U.S. Pat. No. 4,946,904, issued to Akimoto et al., which patent is incorporated by reference as if fully set forth herein.

Another exemplary flexural bond strength enhancing material for use in the present invention may comprise water-soluble linear copolymers of N-vinylamides with monomeric addition products of amines, amino acids, amino groups containing aromatic sulfonic acids, amino alcohols of maleic anhydride as well as maleic esters of polyoxyalkyleneglycols or their monoethers. One structural unit is represented by Formula (A) or by Formula (B); the other partial structure unit being represented by Formula (C):

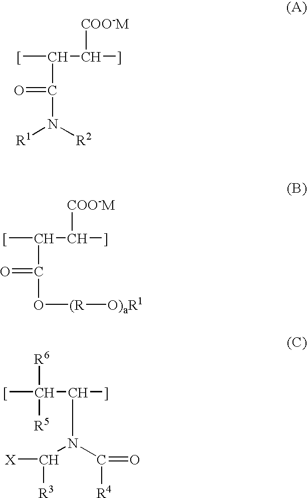

wherein R¹ and R², which may be the same or different, each represent hydrogen, a C₁-C₂₀ alkyl residue which may optionally include alkali metal carboxylate or alkaline earth metal carboxylate groups, an aromatic group, an liphatic or cycloaliphatic residue which may optionally include sulfonic acid groups or alkali metal sulfonate or alkaline earth metal sulfonate groups, a hydroxyalkyl group, preferably a hydroxy ethyl- or hydroxypropyl group, or may together with the nitrogen atom to which they are bound, form a morpholine ring;

M represents a hydrogen ion, a monovalent or divalent metal ion or a substituted ammonium group;

R represents a hydrogen atom or an alkyl group having 1 to 4 carbon atoms; p, q, and r are integers; a represents an integer ranging from 1 to 100;

R³ and R⁴ which may be the same or different, each represent hydrogen, a C₁ to C₁₂-alkyl residue, a phenyl residue, or may together form a di-, tri-, or tetramethylene group, which form with the inclusion of the residue of the formula:

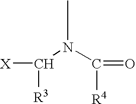

a five, six, or seven membered ring;

R⁵ and R⁶ which may be the same or different, each represent hydrogen, a C₁ to C₁₂-alkyl residue or phenyl residue; and

X represents hydrogen, a C₁ to C₄-alkyl residue, a carboxylic acid group, or an alkali metal carboxylate group. Such copolymer is known and taught in U.S. Pat. No. 5,100,984 issued to Burge et al., and assigned to Sika AG, which patent is incorporated fully by reference as if set forth herein.

In preferred admixture compositions and methods of the invention comprising the at least one C₈-C₃₀ fatty acid, salt, or derivative thereof, and the at least one flexural bond strength enhancing a copolymer, one or more air entraining agents (“AEAs”) can optionally be used to improve workability of a masonry mortar into which the admixture components are introduced. The term “workability” is intended to mean and refer to a qualitative characteristic or ability of the mortar to be trowel-applied conveniently by a skilled mason and such that the resultant masonry mortar demonstrates improved adhesiveness, while in a plastic trowel-applicable state, to the trowel and to a vertical surface (such as the side of a brick or concrete block in a wall that is being assembled). It is believed that the use of an AEA saves labor and improves workmanship.

Exemplary AEAs include salts of a wood resin (e.g., VINSOL® resin); salts of gum rosin acids; synthetic detergents (e.g., fatty alkanolamides, ethoxylated fatty amines, ethoxylated fatty acids, ethoxylated triglycerides, ethoxylated alkylphenols, ethoxylated alcohols, alkyl ethoxylates, alkylaryl ethoxylates; cationic AEAs such as amine ethoxylates and amine oxides; amphoteric AEAs such as betaines; and anionic AEAs such as fatty alkyl ether sulfates; fatty alkylaryl ether sulfates, alkyl benzene sulfonates, sulfosuccinates, and fatty sulfonates); salts of sulfonated lignin; salts of a petroleum acid; salts of a proteinaceous material; fatty and resinous acids and their salts; or salts of sulfonated hydrocarbons.

It is understood that some AEAs may involve a fatty acid component which would appear to overlap with the claimed fatty acids, salts, or derivatives used for obtaining water repellency. However, it is emphasized that preferred compositions and methods of the invention involve AEAs which differ from the water repellent in that they contain higher rosin acid contents. For example, a tall oil (or salt) that is used for water repellency will usually have a rosin acid content of 0 to 10% while a tall oil (or salt) that is used as an AEA will usually have a rosin acid content of 20 to 40%. If two fatty acids are to be deployed, one preferred embodiment of the invention will thus involve the use of a first fatty acid component operative as a water repellent when combined in the mortar, and the use of a second fatty acid operative as an air entraining admixture (AEA); and, further, that the AEA fatty acid will have a higher rosin content than the water repellent fatty acid. It is further expected that the AEA fatty acid will be used in a relatively smaller amount than the water repellent fatty acid.

### EXAMPLE 1

This example illustrates the bond strength problem created by admixtures containing typical water repellency materials. Terms, procedures and materials used for experiments described in this and the following examples are set forth below.

Bond Testing: The strength of the mortar bond between concrete masonry units (CMUs), in this case bricks, is determined using the apparatus and procedure described in ASTM standard C 1072-94, entitled “Standard Test Method for Measurement of Masonry Flexural Bond Strength.” According to this method, brick prisms (assemblies) that are six bricks high and have five mortar joints are prepared. These prisms are stored in a plastic bag and cured for a given time period. They are then tested for flexural bond strength by measuring the flexural force required to break the bond between the mortar and the brick for each mortar joint. Essentially, this flexural bond test entails attaching bars or handles to adjoining bricks or masonry units connected by a mortar joint and measuring the force or load required to twist or “wrench” the bricks apart. Test results for all joints for a given batch of mortar are averaged and reported as average flexural bond strength for that particular mortar/brick combination. All bond strength data reported in these examples represent an average of bond strength of at least 15 bonds.

Water Repellency Testing: Water-repellency of the mortar is quantified using a water uptake test. In this test, the cured mortar sample is placed in 3 mm deep water, and the amount of water absorbed by 30 sq. in. area of mortar sample after 24 hours is reported as the “water uptake” value for that sample. Higher water-repellency is indicated by a lower value of water uptake. In addition, the amount of water required to saturate the sample is measured and reported as “% absorption (grams of water absorbed per gram of mortar sample).” Lower absorption values indicate a higher water-repellency.

### Preparation of Flexural Bond Strength Enhancing Polymers BP-1 and BP-2

The general principle of preparation of bond strength enhancing polymers is based on the method described in U.S. Pat. No. 5,393,343. The two polymer samples (BP-1 and BP-2) used in examples 2 and 3 were prepared as follows:

BP-1: Polyacrylic acid (50% solution, 5000 molecular weight) was combined with a polyethylene-polypropylene oxide polymer (molecular weight 2000) in the mole ratio of 1:17. The polyethylene-polypropylene oxide polymer used in this synthesis contained a primary amine group and a methyl group as the terminal groups. The mixture was heated and maintained at 180° C., while under flowing nitrogen gas stream for a total of 2 hours. The water of solution and formed as by-product was removed in the nitrogen gas stream. Upon cooling to ≈50° C., the reaction product was neutralized with 40% (wt/wt) aqueous NaOH and total solids adjusted to 40% with deionized water. The resulting product was an amber viscous liquid.

BP-2: This polymer was prepared using a similar procedure as that described for the polymer BP-1 except that in this case, polyacrylic acid (50% solution, 5000 molecular weight) was combined with a polyethylene-polypropylene oxide polymer (molecular weight 1000) in the mole ratio of 1:10. The resulting product was an amber viscous liquid.

Other Materials: Two standard Ottawa sands known as “graded sand” and “20-30 sand” were used. These sands meet the requirements of ASTM C778-92, “Standard Specification for Standard Sand,” and are mixed in a 50:50 ratio. The cement used is commercially available Type I cement. In addition, hydrated lime that is commercially available as Type S lime is used. Any chemical admixtures and the amounts, when used, are described as necessary for each experiment.

Mortar Mixing Procedure: A mortar batch is made by mixing 1 part (by weight) portland cement with 0.21 parts hydrated lime, 3.83 parts sand, and water along with any admixtures according to the mortar mixing procedure described in ASTM C 305-94, “Standard Practice for Mechanical Mixing of Hydraulic Cement Pastes and Mortars of Plastic Consistency.” In terms of volume proportions, the mortar contains 1 part portland cement, 0.5 parts hydrated lime and 4.5 parts sand. This mortar mixture meets the prescribed proportion specification of a Type S mortar as described in ASTM C 270-95a, “Standard Specification for Mortar for Unit Masonry.” Sufficient water is added to bring the samples to a standard consistency measured as a flow of 125%±5%. Sample no. 1 contained 0.71 parts of water and no admix. Sample no. 2 contained, as an example of a fatty acid, a calcium stearate dispersion (“CSD”) which is available from PPG Industries, Pittsburgh, Pa., and sufficient amount of water to obtain the same consistency of the mortar as Sample no. 1. For sample no. 2, 0.64 parts of water was used.

Experimental results are summarized in the following table:

TABLE 1

| | | | Results | | | |
|---|---|---|---|---|---|---|
| | | | | | | Flexural |
| | | Parts of | | | | Bond |
| | | Admixture | | | Flexural | Strength |
| | | (Solids | | Water | Bond | Relative |
| | | Based) | | Uptake | Strength, | to Sample |
| Sample | Admixture | per Part | Absorp- | g/30 | psi | 1, % |
| No. | Used | Cement | ption, % | in.² | (7 day) | (7 day) |
| 1 | None | 0 | 9.7% | 182 | 89 | 100% |
| 2 | CSD | 0.007 | 8.1% | 86 | 70 | 79% |

These experiments clearly demonstrate that the calcium stearate dispersion (“CSD”) reduced the absorption and water uptake of the mortar significantly, thus making it more water-repellent. However, the flexural bond strength was reduced from 89 to 70 psi due to the presence of the CSD water-repelling agent, a reduction of 21%.

### EXAMPLE 2

This example illustrates a preferred embodiment of the invention having CSD and a flexural bond strength enhancing polymer BP-1. The mortar achieved both water-repellency and flexural bond strength enhancement.

TABLE 2

| | | | Results | | | |
|---|---|---|---|---|---|---|
| | | | | | | Flexural |
| | | Parts of | | | | Bond |
| | | Admixture | | | Flexural | Strength |
| | | (Solids | | Water | Bond | Relative |
| | | Based) | | Uptake, | Strength, | to Sample |
| Sample | Admixture | per Part | Absorp- | g/30 | psi | 1, % |
| No. | Used | Cement | tion, % | in.² | (7 day) | (7 day) |
| 1 | None | 0 | 9.7% | 182 | 89 | 100% |
| 2 | CSD | 0.007 | 8.1% | 86 | 70 | 79% |
| 3 | CSD + | 0.007 + | 7.4% | 68 | 118 | 133% |
| | BP-1 | 0.0018 | | | | |

Thus, it is clear that the CSD+BP-1 mixture (Sample 3) improved the flexural bond strength from 70 psi (for CSD alone, Sample 2) to 118 psi; a surprising 69% improvement. At the same time, the water-repellency of the mortar also improved in comparison with the mortar that contained the CSD alone as seen by significant reductions in the percentage absorption and water uptake values. Therefore, the CSD+BP-1 mixture not only improved the flexural bond strength, but also this two-component mixture enhanced the water-repellency, an achievement which suggests a strong synergism in the two-component compositions, cements, and methods of the present invention.

### EXAMPLE 3

This example describes another embodiment of the invention wherein other flexural bond strength enhancing polymers, having a carbon-containing backbone to which are attached cement-anchoring members and oxyalkylene groups, are employed. For example, polymers available under the tradename Malialim AKM-0531 from Nippon Oils and Fats Co., Ltd., Tokyo, Japan, and Narlex LD-42 (available from National Starch & Chemical Company, Bridgewater, N.J.) were used in addition to polymer BP-2 to prepare further exemplary admixtures of the present invention. These admixtures also showed improved flexural bond strength enhancing properties when incorporated into the mortar with the calcium stearate dispersion, although the bond strength improvements with Malialim AKM-0531 and Narlex LD-42 were not as much as those observed with BP-1 and BP-2. The following table summarizes the bond strengths of mortars using these polymers relative to the bond strength of mortar without any admix.

TABLE 3

| | | | | Flexural |
|---|---|---|---|---|
| | | Parts of | Flexural | Bond |
| | | Admixture | Bond | Strength |
| | | (Solids | Strength, | Relative to |
| Sample | Admixture | Based) per | psi | Sample 1, % |
| No. | Used | Part of Cement | (7 day) | (7 day) |
| 1 | None | 0 | 89 | 100% |
| 2 | CSD | 0.007 | 70 | 79% |
| 3 | CSD + BP-1 | 0.007 + 0.0018 | 118 | 133% |
| 4 | CSD + BP-2 | 0.008 + 0.0014 | 123 | 138% |
| 5 | CSD + | 0.008 + 0.0012 | 110 | 124% |
| | Malialim | | | |
| | AKM-0531 | | | |
| 6 | CSD + | 0.008 + 0.0015 | 83 | 93% |
| | Narlex | | | |
| | LD-42 | | | |

As shown by the figures for flexural bond strength after 7 days, each of the combinations of CSD+bond strength enhancing polymer provided a flexural bond strength that far exceeded the 79% figure for CSD alone, and suggests a strong synergism in the two-component compositions, cements, and methods of the present invention.

### EXAMPLE 4

This example illustrates another preferred embodiment of the invention having CSD, a flexural bond strength enhancing polymer BP-1 and an air entraining agent (“AEA”). The AEA contains a high rosin acid content (e.g., greater than 20% in AEA) tail oil (and such an AEA is commercially available from a number of sources). A different cement was used to make the mortar in this example. As shown in Table 4 below, the flexural bond strength of the control, Sample No. 7, (82 psi) is comparable to that of the control, Sample No. 1, in examples 1 through 3 (89 psi). The mortar achieved both water-repellency, flexural bond strength enhancement, and improved workability.

The following table summarizes the bond strengths of mortars using this combination of CSD, polymer and AEA relative to the bond strength of mortar without any admix.

TABLE 4

| | | Parts of | | Flexural |
|---|---|---|---|---|
| | | Admixture | Flexural | Bond |
| | | (Solids | Bond | Strength |
| | | Based) per | Strength, | Relative to |
| Sample | Admixture | Part of | psi | Sample 7, % |
| No. | Used | Cement | (7 day) | (7 day) |
| 7 | None | 0 | 82 | 100% |
| 8 | CSD + | 0.006 + | 148 | 180% |
| | BP-1 + | 0.0018 + | | |
| | AEA | 0.00007 | | |

As shown by the figures for flexural bond strength after 7 days, the combination of CSD+BP-1+AEA provided a flexural bond strength that far exceeded the mortar without any admixture.

The improvement in workability by adding the AEA is shown by the observations of two masons (each with at least 15 years of experience) from the National Concrete Masonry Association Laboratory (“NCMA”), Herndon, Va. The masons made batches of Type S Portland cement/Lime mortar under job-site conditions and judged the workability of each batch. Workability was judged in terms of qualitative ease of applicability of the mortar as well as “hangability,” or, in other words, the ability of the mortar to adhere to vertical surfaces such as brick or concrete surfaces (known as head joints). The following table summarizes their observations.

TABLE 5

| | | Parts of | |
|---|---|---|---|
| | | Admixture | |
| | | (Solids | Workability |
| Sample | Admixture | Based) per | Observations from |
| No. | Used | Part of Cement | Masons at NCMA Lab |
| 9 | None | 0 | OK workability. Plastic |
| | | | mortar adhered well in |
| | | | vertical head joints. |
| 10 | CSD + | 0.006 + | Not as good as #9. |
| | BP-1 | 0.0018 | Plastic mortar did not |
| | | | adhere well in vertical |
| | | | head joints. |
| 11 | CSD + | 0.006 + | Good workability. Much |
| | BP-1 + | 0.0018 + | better than #10. |
| | AEA | 0.00007 | Better than #9. |
| | | | Plastic mortar adhered |
| | | | well in vertical head |
| | | | joints. |

As shown by the workability observations, the combination of CSD+BP-1+AEA rendered the mortar much more workable than did the CSD+BP-1 combination, and was more workable than the mortar without any admixture. Surprisingly, a relatively very small amount of the AEA improved workability drastically.

### EXAMPLE 5

Other exemplary admixture compositions of the invention are made by substituting the calcium stearate used in Example 2 with zinc stearate, zinc palmitate, zinc oleate, zinc myristate, butyl stearate, butyl palmitate, butyl oleate, butyl myristate, calcium oleate, and calcium myristate, to make various combinations with either or both of the flexural bond strength enhancing polymer BP-1 or BP-2, as described above in Example 1. It is expected that increased flexural bond strength will be evident, as well as lower absorption and water uptake values in the mortar, for each of these sample combinations.

### EXAMPLE 6

Further exemplary admixture composition can be made by adding to each of the combinations described in Example 5 a small amount of an AEA, such as described above in Example 4. It is expected that increased flexural bond strength and improved workability will be evident, as well as lower absorption and water uptake values in the mortar, for each of these sample combinations.

### EXAMPLE 7

Further exemplary admixture composition are made substituting for the AEA used in Example 6 other AEAs such as a salt of VINSOL® resin or a salt of Gum Rosin. An improved workability in the mortar is thus expected in comparison to a sample not having the AEAs.

The foregoing examples are provided for illustration only and are not intended to limit the scope of the invention.

We claim:

1. A composition for improving water repellency and flexural bond strength in mortar, comprising: (a) at least one C₈-C₃₀ fatty acid or a derivative thereof; and (b) at least one flexural bond strength enhancing material comprising a polymer having a carbon-containing backbone to which are attached cement-anchoring members and oxyalkylene groups attached by linkages selected from the group consisting of an amide, an imide, and an ester.

2. The composition of claim 1 wherein said at least one C₈-C₃₀ fatty acid derivative comprises a salt, ester, or triglyceride.

3. The composition of claim 2 wherein said at least one C₈-C₃₀ fatty acid comprises an insoluble salt in a dispersion form.

4. The composition of claim 1 wherein said at least one C₈-C₃₀ fatty acid or derivative thereof is represented by the formula:
R_{FA}COO-A
wherein R_{FA} represents a C₇-C₂₉ alkyl(ene) group; and A═H, a C₁-C₁₂ linear or branched alkyl group, an alkali or alkaline earth metal cation, a polyvalent cation, a glycerol moiety (e.g., a polyhydroxy alcohol), or a C₁-C₁₂ linear or branched alkyl or alkanol amine.

5. The composition of claim 4 wherein said at least one C₈-C₃₀ fatty acid or derivative thereof comprises a calcium stearate, a calcium palmitate, a zinc stearate, a zinc palmitate, a butyl stearate, a butyl palmitate, a tall oil which contains oleic and lineoleic acid, a sodium tallate, potassium tallate, a butyl oleate, or a mixture thereof.

6. The composition of claim 2 wherein said at least one C₈-C₃₀ fatty acid or derivative thereof comprises a calcium stearate, a calcium palmitate, or a mixture thereof.

7. The composition of claim 1 wherein said at least one C₈-C₃₀ fatty acid or derivative thereof comprises a myristate or laurate.

8. The admixture of claim 1 wherein said at least one C₈-C₃₀ fatty acid or a derivative thereof is in the amount of 5-97% total dry weight solids, and said bond strength enhancing material is present in the amount of 1-95% total dry weight solids.

9. The admixture of claim 1 wherein said copolymer is formed by reacting an acrylic polymer with ammonia or an alkoxylated amine represented by the formula:
H₂N—(BO)ₙ—R″
in which BO represents a C₂-C₁₀ (preferably a C₂-C₄ ) oxyalkylene group in which O represents an oxygen atom and B represents a C₂-C₁₀ (preferably a C₂-C₄) alkylene group or mixture; and R″ represents a C₁-C₁₀ (preferably C₁-C₄) alkyl group and n is an integer selected from 1 to 200 and preferably from 1 to 70.

10. The admixture of claim 1 wherein said copolymer comprises a carbon containing backbone to which is attached groups shown by the following structures (I) and (II) and optionally (III) and (IV): 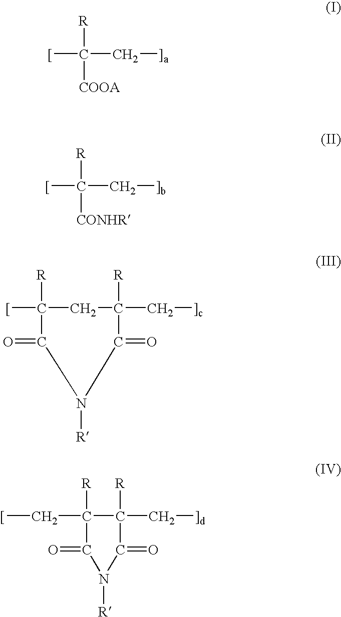
wherein each R independently represents a hydrogen atom or a methyl group (—CH₃) group; A represents hydrogen atom, a C₁-C₁₀ alkyl group, R′ or an alkali metal cation or a mixture thereof; R′ represents a hydrogen atom or a C₂-C₁₀ oxyalkylene group represented by (BO)ₙR″ in which O represents an oxygen atom, B represents a C₂-C₁₀ alkylene group, R″ represents a C₁-C₁₀ alkyl and n represents an integer of from 1-200, or mixtures thereof; and a, b, c, and d are numerical values representing molar percentage of the polymer's structure such that a is a value of about 50-70; the sum of c plus d is at least 2 to a value of (100−a) and is preferably from 3 to 10; and b is not more than [100−(a+c+d)].

11. The admixture of claim 10 wherein said copolymer further comprises at least one group from the structures (III) and (IV): 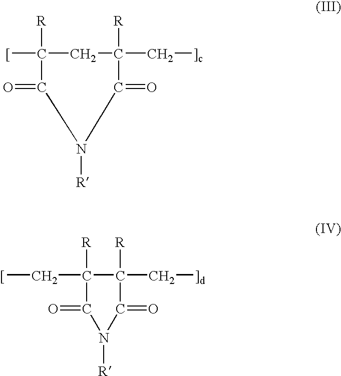
wherein A is a hydrogen atom or an alkali metal cation; R′ is at least from 50-90 weight percent of the polymer and comprises polyoxyethylene or polyoxypropylene units or mixtures thereof; a has a numerical value of from 60-70, and the sum of c and d is a numerical value of at least 3 (preferably at least 5) to the value of (100−a).

12. The admixture of claim 1 wherein said copolymer is formed by reacting an acrylic polymer with ammonia, an alkoxylated amine or polyoxyalkylene alcohol to provide a functional side chain represented by the formula
R⁴—(OA²)ₓ—Q—
wherein Q=O or NH;
A²=C₁-C₁₀ alkylene;
x=1 to 200; and
R⁴=C₁-C₁₀ alkyl.

13. The composition of claim 12 wherein said A²=C₂-C₅ alkylene; and said OA² comprises ethylene oxide, propylene oxide, or a combination thereof.

14. The admixture of claim 13 wherein said copolymer comprises a carbon-containig backbone having cement attaching groups and oxyalkylene groups attached to the backbone by a linkage selected from amide and imide, said groups having the structures (I) and (II), and optionally structures (III) and (IV): 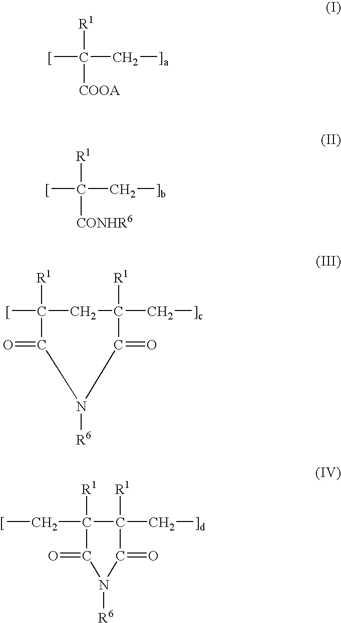
wherein each R¹ independently represents a hydrogen atom or a C₁-C₅ alkyl (preferably methyl (CH₃—)) group; A represents a mixture of Z and R²; Z represents hydrogen atom, monovalent or divalent metal cation, ammonium group or organic amine group; R² represents an air detraining polyoxyalkylene group represented by (BO)ₙR³ in which O represents an oxygen atom, B represents a C₁-C₁₀ alkylene group, R³ represents a C₁-C₁₀ alkyl group and n represents an integer of from 1-200, or mixtures thereof; R⁶ represents a polyoxyalkylene group represented by (BO)ₙR³; and a, b, c and d are numerical values representing molar percentage of the polymer's structure such that a is a value of about 1 to 99; the sum of c+d is a value of 0 to the numerical value of (100−a); and b is a remainder value of [100−(a+c+d)].

15. The admixture of claim 14 wherein said copolymer comprises an imidized acrylic polymer and further comprises at least one of the structures (III) and (IV).

16. The composition of claim 1 wherein said (a) at least one C₈-C₃₀ fatty acid or a derivative thereof; and (b) at least one flexural bond strength enhancing material comprising a copolymer are mixed together and thereby operative to be introduced into masonry mortar as one additive.

17. The composition of claim 1 wherein said flexural bond strength enhancing material comprises a copolymer of a polyoxyalkylene derivative and a maleic anhydride.

18. The composition of claim 1 wherein said flexural bond strength enhancing material comprises linear copolymers of N-vinylamides with addition products selected from the group consisting of amines, amino acids, amino groups containing aromatic sulfonic acids, amino alcohols of maleic anhydride, and maleic esters of polyoxyalkyleneglycols or their monoethers.

19. The composition of claim 1 further comprising an air entraining admixture operative to improve the workability of a masonry mortar into which said composition is added.

20. The composition of claim 19 wherein said air entraining admixture is selected from salts of a wood resin; salts of gum rosin acids; synthetic detergents; salts of sulfonated lignin; salts of a petroleum acid; salts of a proteinaceous material; fatty and resinous acids and their salts; alkylbenzene sulfonates; or salts of sulfonated hydrocarbons.

21. The composition of claim 20 wherein said at least one C₈-C₃₀ fatty acidor derivative thereof is present in the amount of 5 to 97% dry weight, said at least one flexural bond strength enhancing material is present in the amount of 1 to 95% dry weight; and said air entraining agent is present in the amount of 0.01 to 10.0% dry weight; said percentage dry weight ranges being based on the total dry weight of said composition.

22. A cementitious composition comprising (a) a cement; (b) at least one C₈-C₃₀ fatty acid or a derivative thereof; and (c) at least one flexural bond strength enhancing material comprising a copolymer having a carbon-containing backbone to which are attached cement-anchoring members and oxyalkylene groups attached by linkages selected from the group consisting of an amide, an imide, and an ester.

23. The composition of claim 22 further comprising an air entraining agent.

24. The composition of claim 22 wherein said at least one C₈-C₃₀ fatty acid comprises a calcium stearate.

25. The composition of claim 22 wherein said composition is a masonry mortar.

26. Method for simultaneously improving flexural bond strength and water repellency in a mortar composition, comprising: combining into a mortar composition comprising a cementitious binder and sand (1) at least one C₈-C₃₀ fatty acid or a derivative thereof; and (2) at least one masonry bond strength enhancing material comprising a copolymer having a carbon-containing backbone to which are attached cement-anchoring members and oxyalkylene groups attached by linkages selected from the group consisting of amide, imide, and ester.

27. The method of claim 26 wherein said at least one flexural bond strength enhancing material comprises a copolymer having a carbon containing backbone to which is attached groups shown by the following structures (I) and (II) and optionally (III) and (IV): 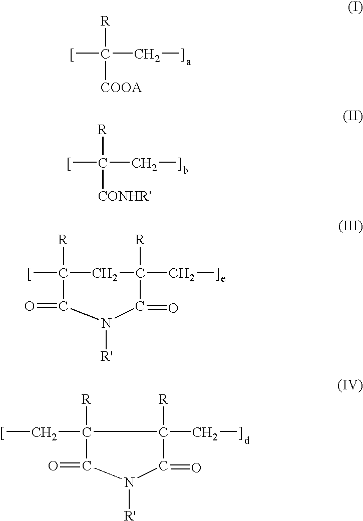
wherein each R independently represents a hydrogen atom or a methyl group (—CH₃) group; A represents hydrogen atom, a C₁-C₁₀ alkyl group, R′ or an alkali metal cation or a mixture thereof; R′ represents a hydrogen atom or a C₂-C₁₀ oxyalkylene group represented by (BO)ₙR” in which O represents an oxygen atom, B represents a C₂-C₁₀ alkylene group, R″ represents a C₁-C₁₀ alkyl and n represents an integer of from 1-200, or mixtures thereof; and a, b, c, and d are numerical values representing molar percentage of the polymer's structure such that a is a value of about 50-70; the sum of c plus d is at least 2 to a value of (100−a) and is preferably from 3 to 10; and b is not more than [100−(a+c+d)].

28. The method of claim 27 further comprising introducing into the mortar an air entraining agent.

29. The composition of claim 1 wherein said copolymer backbone comprises a carboxylic acid, an acrylic acid, a methacrylic acid, a maleic acid, a fumaric acid, a citraconic acid, an itaconic acid, a (meth)allylsulfonic acid, a vinyl sulfonic acid, or mixture thereof.
